(19) United States
(12) Patent Application Publication
(10) Pub. No.: US 2013/0313896 A1
(43) Pub. Date: Nov. 28, 2013

(54) POWER SUPPLY DEVICE, METHOD FOR DISCONNECTING A BATTERY FROM A CONNECTION DEVICE AND MOTOR VEHICLE

(71) Applicants: Michael Gless, Stuttgart-Zazenhausen (DE); Ralf Angerbauer, Moglingen (DE)

(72) Inventors: Michael Gless, Stuttgart-Zazenhausen (DE); Ralf Angerbauer, Moglingen (DE)

(73) Assignee: Robert Bosch GmbH, Stuttgart (DE)

(21) Appl. No.: 13/881,506

(22) PCT Filed: Sep. 2, 2011
(86) PCT No.: PCT/EP11/65160

§ 371 Date: Aug. 16, 2013

(30) Foreign Application Priority Data
Oct. 27, 2010 (DE) 10 2010 042 992.9

(51) Int. Cl. B60L 3/00; H02J 1/00

(52) U.S. Cl. CPC B60L 3/00; H02J 1/00
USPC 307/10.1; 307/112

(57) ABSTRACT

A power supply device includes a first electric line and at least one battery connected to the first electric line. In one embodiment, the at least one battery is a lithium-ion battery. The power supply device also includes an electrically operable circuit breaker arranged in the first electric line and configured to interrupt a current flow in the first electric line. The power supply device further comprises a second electric line configured to supply power to the circuit breaker. An over current protection device is arranged in the second electric line and is configured to interrupt a current flow in the second electric line to control the circuit breaker so as to interrupt the current flow in the first electric line.

The present invention relates to a power supply device which comprises a first electrical line and at least one battery connected thereto and an electrically actuatable isolating switch, which is arranged in the first electrical line, for interrupting a flow of current in the first electrical line.

In addition, the invention relates to a method for isolating a battery from a connection device, coupled to the battery by a first electrical line, by means of an electrically actuatable isolating switch, which is arranged in the first electrical line, for interrupting a flow of current in the first electrical line.

Furthermore, the present invention relates to a motor vehicle which has the power supply device of the invention.

### PRIOR ART

It can be necessary, in particular when using lithium-ion batteries in motor vehicles, to switch the entire onboard power supply system of the motor vehicle to zero potential for maintenance and/or repair purposes. In this case, in order to prevent the onboard power supply system from being switched back on unintentionally or without authorization while the repair or maintenance work is being performed, it is necessary to ensure that it is not possible for the onboard power supply system to be easily switched back on. In order for said system to be switched back on, at least one additional operation needs to be performed, which can be assumed not to be known by unauthorized persons or not to be able to be performed unintentionally.

For this purpose, so-called service plugs are provided, which essentially have the design of a protective switch. Alternatively, fuses are used. Both embodiments are preferably arranged on the outside of a battery housing such that they are manually accessible. When the so-called service plug is tripped, said plug must be manually switched back into the closed state in order to allow the power supply system to be switched back on. When a fuse is tripped, this must be manually replaced in order to enable the system to be switched back on.

A disadvantage of the aforesaid embodiments is that, owing to electrical contacts being fed through from the respective fuse to the battery, openings must be present in the housing, which openings possibly cause leaks in the housing and thus can possibly lead to a reduction in the service life of the battery held in the housing because of disadvantageous temperature, pressure and/or moisture levels. Moreover, the arrangement of the aforesaid fuse on the battery housing is elaborate in terms of design, resulting in higher manufacturing costs. The arrangement of the fuse outside the battery-housing interior is necessary, however, in order to ensure manual accessibility.

An aforesaid service plug is disclosed in DE 10 2008 028 933 A1, for example, and is called a circuit-breaker device therein.

The documents JP 2008 243 710 A and US 2008/0297303 A1 show electrical systems in which safety devices in the form of a service plug are arranged in a power line directly connected to the battery. The circuit in which the battery is arranged is isolated by means of the service plug being tripped and so the battery is decoupled from the rest of the power supply system and maintenance and/or repair work can be performed.

In this case, the service plug must have an appropriately high electrical conductivity for it to be able to conduct the current provided by the battery. In this case, it can be assumed that the higher the electrical power to be transferred in a line, the larger and more expensive the corresponding fuse must be.

Isolation of the electrical line connected to the battery is implemented when the service plug is accordingly manually switched or else removed from the line or when an overcurrent of the type which trips the service plug exists in the electrical line.

The conventional power supply device can be seen from the attached FIGS. 1 and 2.

First of all, reference is made to FIG. 1.

A conventional power supply device, in particular a power supply device for driving a motor vehicle which can be driven by an electric motor, comprises a battery 1, which optionally has a plurality of battery cells 2, which are arranged in at least one battery housing 3. The battery 1 is connected to a charging and isolating device 11 by means of a first electrical line 10. Said charging and isolating device 11 comprises an isolator switch 13 and a charging switch 14 and a charging resistor 15 connected in series with said charging switch.

As can be seen from FIG. 1, the charging and isolating device 11 can be arranged between a positive pole and the battery 1. To increase safety, a further isolating device 12 with a further isolating switch 13 can be arranged in an electrical line between the negative pole of the onboard power supply system and the battery 1.

The charging switch 14 is closed when the battery 1 is intended to be charged.

The isolating switch 13 can be manually opened such that the battery 1 is isolated from the positive pole and/or negative pole of the power supply system and repair or maintenance work can be performed safely.

FIG. 2 essentially shows the conventional power supply device which has already been explained in connection with FIG. 1, the power supply device shown in FIG. 2 additionally having an overcurrent protection device 21 in the first electrical line 10, however. Said overcurrent protection device 21 isolates the first electrical line 10 when an overcurrent is present in the first electrical line 10. Thus the battery 1 can be isolated from the power supply system in the event of a fault which leads to an overcurrent in the first electrical line 10. Optionally, the overcurrent protection device 21 may be removable from the first electrical line, and/or able to be switched off, manually.

### DISCLOSURE OF THE INVENTION

According to the invention, a power supply device which comprises a first electrical line and at least one battery, in particular a lithium-ion battery, connected thereto and an electrically actuatable isolating switch, which is arranged in the first electrical line, for interrupting a flow of current in the first electrical line is provided. According to the invention, the power supply device also has a second electrical line for supplying power to the isolating switch, wherein an overcurrent protection device is arranged in the second electrical line and can be used to interrupt a flow of current in the second electrical line, and thus the isolating switch can be controlled in such a way that it interrupts the flow of current in the first electrical line.

A power supply device of this type can also be referred to as a battery system, wherein said battery system can have a plurality of batteries or battery cells, which are optionally arranged in so-called battery packs. The isolating switch is preferably configured in such a way that it closes in the energized state and so, in the event of the overcurrent protection device being tripped and the associated isolation of the second electrical line, the isolating switch is opened and thus the battery connected to the first electrical line is no longer connected to the entire power supply system. Maintenance work can then be carried out safely and, in the event of a malfunction, the danger of damage to the battery and, possibly, a battery management system connected to the battery and/or the surroundings of the battery can at least be reduced.

The advantage of the invention is in particular that isolation of the first electrical line connected to the battery can also take place when the overcurrent protection device in the second electrical line trips. Said tripping can be realized by means of an overcurrent in the second electrical line and/or when a fault occurs in the battery or in the onboard power supply system.

Since the overcurrent protection device is arranged in the second electrical line, it can be integrated in a housing which holds the battery as well as a battery management system such that no housing openings which could cause leaks are present. As a result, it is possible to save on manufacturing costs for the housing. In addition, a longer service life can be ensured for the battery owing to the improved separation from the environment.

Preferably, the power supply device according to the invention comprises the aforesaid battery management system which is electrically connected to the second electrical line and is configured in such a way that, when an inadmissible deviation of an actual parameter, which is detected by the battery management system, from a predefined setpoint parameter is determined, the second electrical line is controlled by the battery management system in such a way that a flow of current which can cause the overcurrent protection device to be tripped can be produced in the second electrical line.

In this case, the first electrical line is configured for application of a first electrical voltage and the second electrical line is configured for application of a second electrical voltage, wherein the first voltage is higher than the second voltage. Preferably, the first voltage is in a range which is required for the operation of a motor vehicle which is driven by an electric motor. This can be the high-voltage or medium-voltage range, namely in the range up to 800 V.

In contrast, the voltage range for which the second electrical line is configured is a low-voltage range, namely a low voltage of up to 50 V AC or 120 V DC. In order to eliminate health hazards, the voltage should be lower than 60 V.

The aforesaid setpoint parameter can optionally also comprise a range. Owing to the aforesaid configuration, when the battery management system determines an operating fault or a battery fault, said battery management system can easily control the overcurrent protection device in such a way that the overcurrent protection device isolates the second electrical line and thus causes the isolating switch in the first electrical line to be opened and, as a result, the battery to be isolated from the rest of the power supply system. The battery management system can therefore easily prompt the isolation of the first electrical line, and therefore decouple the battery from further electrical assemblies, when any undesirable deviation or a fault or misuse is detected.

In a further preferred configuration, the power supply device comprises an additional switch, which can be controlled by the battery management system, in the second electrical line, that is to say that an additional switch is arranged in series preferably between the overcurrent protection device and the isolating switch, which additional switch must likewise be closed for the isolating switch to remain closed and the battery to remain connected to the power supply system.

A first fuse can be arranged in the first electrical line in order to protect the power supply device further. Alternatively, a protective switch can also be arranged in the first electrical line. The first fuse or else the protective switch in the first electrical line provides direct protection for the battery and/or the power supply system connected thereto against overload currents.

In a first alternative of the overcurrent protection device, the latter is configured as a fuse, that is to say that the power supply device, insofar as it has the aforesaid first fuse in the first electrical line, can furthermore have a second fuse, namely in the second electrical line.

Said second fuse can optionally have plug-in contacts so that it can be manually plugged into the second electrical line and also pulled out again. The resistance of the second fuse is substantially lower than the resistance of the first fuse, since the second fuse is arranged in an electrical line which is configured for a substantially lower electrical power than the first electrical line.

The fuse in the second electrical line can have a thread in order to be screwed into a screw socket and to complete a circuit there on the basis of contact being made.

A third alternative is the design of the fuse as a plug-in fuse or a clamped fuse, which ensures the electrical connection on the basis of clamping forces between two contacts. When the fuse is used as a clamped fuse in a motor vehicle, an additional mechanical lock, preferably with a positively locking action, for fixing the fuse can be arranged, for example an eccentric or a clip.

In addition to the configuration as a fuse, the overcurrent protection device can also be designed as a circuit breaker.

The current in the second electrical line, which is prompted by the battery management system, must be large enough to cause the fuse to blow or the circuit breaker to open in the second electrical line. In this case, however, the resistance of the overcurrent protection device in the form of the fuse or the circuit breaker should be sufficiently high in order not to be tripped just by the supply currents during normal operation when the second electrical line is used as a power supply line for the battery management system.

When the overcurrent protection device is configured as a fuse or as a circuit breaker, blowing of the fuse or switching-off of the circuit breaker prevents the isolating switch from being easily switched back on and so further steps, for example replacing the fuse or switching on the circuit breaker, are necessary in order to switch on the isolating switch. This substantially reduces the risk of the isolator switch being switched back on without authorization or inadvertently during maintenance or repair work. Moreover, when the battery management system has initiated switching-off of the battery because of a fault or defect which has arisen, the battery is prevented from being easily switched back on.

When the overcurrent protection device is configured as a fuse or as a circuit breaker, it can be provided that the fuse can be manually removed or the circuit breaker can be manually switched. The effect which can be achieved thereby is that a flow of current in the second electrical line can be interrupted, and thus the isolating switch in the first electrical line can also be tripped, manually. The fuse can be removed when necessary, so that the danger of the battery system being inadmissibly or involuntarily switched back on is further reduced. When the overcurrent protection device is configured as a circuit breaker, the latter is arranged on the housing in such a way that it can be operated manually. Optionally, an operating element of the circuit breaker can be mechanically blocked against inadmissible or involuntary switch-on. A flap is suitable for this purpose, which flap is arranged over a cutout in the housing, in which cutout the circuit breaker is arranged for the purposes of sealing and protecting the circuit breaker.

In this case, however, it is not imperative for an opening to be present in the battery housing for feeding through lines for the overcurrent protection device, since the overcurrent protection device is connected to the battery management system, which can also optionally be arranged outside the battery housing.

According to the invention, a method for isolating a battery, in particular a lithium-ion battery, from a connection device coupled to the battery by a first electrical line is also provided, wherein the isolation of the battery from the connection device is effected by means of an electrically actuatable isolating switch, which is arranged in the first electrical line, for interrupting the flow of current in the first electrical line. In a second electrical line, which serves to supply power to the isolating switch, an overcurrent protection device interrupts the flow of current, as a result of which the isolating switch is controlled in such a way that it interrupts the flow of current in the first electrical line. In this case, the aforesaid connection device serves to connect at least one electrical assembly intended to be powered by the battery. The connection device can therefore in particular be an onboard power supply of a motor vehicle.

The method is preferably configured such that a battery management system controls the second electrical line in such a way that a flow of current is produced in the second electrical line, which flow of current causes the overcurrent protection device to be tripped.

The battery management system can also control an additional switch, wherein the overcurrent protection device and the additional switch are connected in series and therefore electrically ANDed. In this case, the additional switch is preferably a break-contact and so, when a relevant flow of current is switched on by the battery management system in the second electrical line and thus the overcurrent protection device is tripped and/or the additional switch is opened by the battery management system, the isolating switch is opened and thus the first electrical line is isolated. Therefore, the overcurrent protection device can respond to an overcurrent in the second electrical line and to any faults which are detected by the battery management system and cause the battery management system to apply an overcurrent to the second electrical line, which overcurrent leads to the overcurrent protection device being tripped, and/or the additional switch to be opened. In order to open the isolating switch, it is sufficient in this case to trip the overcurrent protection device or open the additional switch. In order to ensure the connection of the battery to the power supply system, it is necessary, however, for a current to flow through the overcurrent protection device and through the additional switch.

In addition, a motor vehicle, in particular a motor vehicle which can be driven by an electric motor, is provided according to the invention, which motor vehicle comprises a power supply system according to the invention. In this case, the aforesaid first electrical line may be part of a high-voltage onboard power supply system to which the drive motor of the motor vehicle is connected.

### DRAWINGS

The invention will be explained in the text below with reference to the exemplary embodiments illustrated in the attached drawings, in which:

FIG. 1 shows a conventional power supply device,

FIG. 2 shows a conventional power supply device with a service device,

FIG. 3 shows a power supply device of the invention,

FIG. 4 shows a fuse in a screw socket, and

FIG. 5 shows a fuse with plug-in contacts.

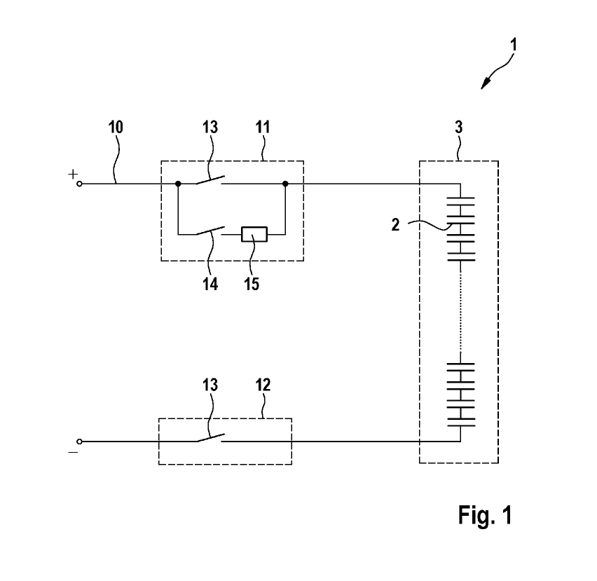

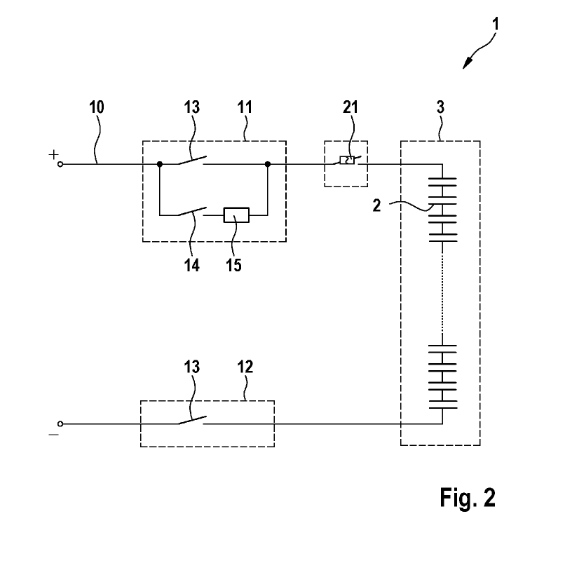

Reference has already been made to FIGS. 1 and 2 to explain the prior art.

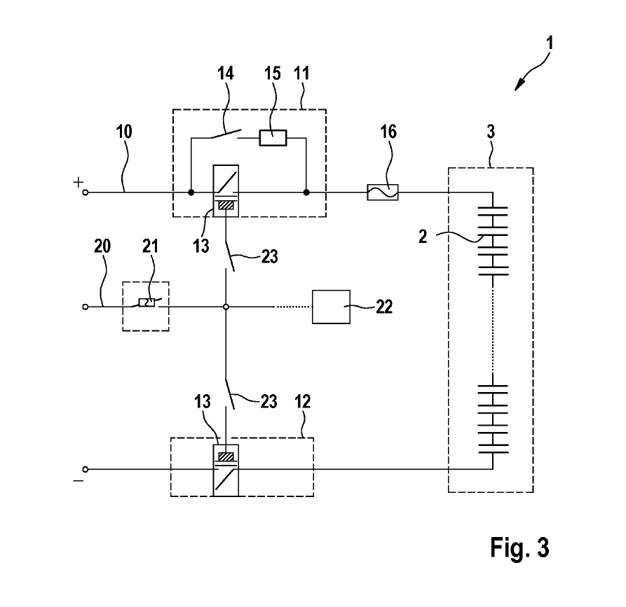

In order to explain the present invention, reference is made to FIG. 3. In contrast to the conventional power supply device illustrated in FIGS. 1 and 2, the power supply device of the invention has a second electrical line 20, in which the overcurrent protection device 21 is arranged. The overcurrent protection device 21 is connected in series with the isolating switch 13, wherein the isolating switch 13 is electrically actuatable, that is to say that the isolating switch 13 is closed only when it is supplied with current. When the overcurrent protection device 21 in the second electrical line 20 is tripped, the flow of current in the second electrical line 20 is therefore interrupted and the isolating switch 13 is no longer supplied with current, which means that said isolator switch opens the first electrical line 10 and thus decouples the battery 1 from the power supply system.

A power supply device of the invention can be arranged between a positive pole and the battery 1 and/or between a negative pole and the battery, wherein the positive and negative poles can be coupling points on a power supply system, in particular on an onboard power supply system, and so the battery 1 can be isolated from the onboard power supply system by means of the invention.

Preferably, the battery management system 22 is also connected to the second electrical line 20, which battery management system can be configured in such a way that it detects faults during operation of the battery 1 and/or of the power supply system. When such a fault is detected, the battery management system 22 is advantageously able to produce an overcurrent in the second electrical line 20 of a kind that leads to the overcurrent protection device 21 being tripped and thus, as already described, isolates the battery 1 from the power supply system.

In order to further increase safety, it can be provided that there is an additional switch 23 arranged in series with the overcurrent protection device 21, which additional switch can likewise be controlled by the battery management system 22 in a preferred configuration of the invention. Therefore, the battery management system 22 can provide the second electrical line 20 with an overcurrent and/or open the additional switch 23 when said system detects a fault. However, the overcurrent protection device 21 can also be tripped independently of the battery management system 22 detecting a fault, in the event of an overcurrent which was not caused by the battery management system 22 occuring in the second electrical line 20.

In order to likewise provide protection against overcurrents in the first electrical line 10, an overcurrent protection device, for example in the form of a first fuse 16, can also be arranged, as illustrated in FIG. 3, in the first electrical line 10.

The overcurrent protection device 21 in the second electrical line 20 can be configured, as mentioned above, as a fuse or else as a circuit breaker.

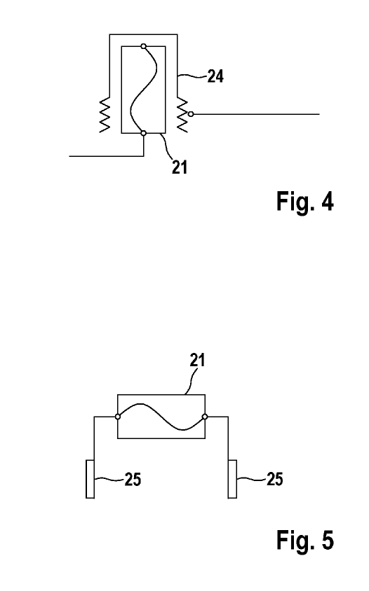

When configured as a fuse, said overcurrent protection device can be provided with a thread and screwed into a correspondingly configured screw socket 24, as illustrated in FIG. 4.

In an alternative configuration, the overcurrent protection device 21 in the form of a fuse can have plug-in contacts 25.

Since the overcurrent protection device 21 can be screwed in or the overcurrent protection device 21 can be plugged in, said device can be easily integrated into the second electrical line 20 manually. This allows easy and quick removal of the overcurrent protection device 21 from the second electrical line 20 and therefore opening of the isolating switch 13, combined with increased safety against said switch being switched back on without authorization or involuntarily.

1. A power supply device comprising:
a first electrical line;
at least one battery, connected to the first electrical line;
an electrically actuatable isolating switch arranged in the first electrical line and configured to interrupt a flow of current in the first electrical line;
a second electrical line configured to supply power to the isolating switch; and
an overcurrent protection device arranged in the second electrical line and configured to interrupt a flow of current in the second electrical line to control the isolating switch so as to interrupt the flow of current in the first electrical line.

2. The power supply device as claimed in claim 1, further comprising:
a battery management system electrically connected to the second electrical line and configured such that, when an inadmissible deviation of an actual parameter, which is detected by the battery management system, from a predefined setpoint parameter is determined, the battery management system controls the second electrical line such that a flow of current configured to trip the overcurrent protection device is produced in the second electrical line.

3. The power supply device as claimed in claim 2, further comprising an additional switch arranged in the second electrical line and configured to be controlled by the battery management system.

4. The power supply device as claimed in claim 1, further comprising a first fuse in the first electrical line.

5. The power supply device as claimed in claim 1, wherein the overcurrent protection device is a second fuse.

6. The power supply device as claimed in claim 1, wherein the overcurrent protection device is a circuit breaker.

7. The power supply device as claimed in claim 1, further comprising a battery housing,
wherein the overcurrent protection device is arranged on an outer side of the battery housing,
wherein the overcurrent protection device is manually removable when configured as a second fuse, and
wherein the overcurrent protection device is manually switchable when configured as a circuit breaker.

8. A method for isolating a battery from a connection device coupled to the battery by a first electrical line, comprising:
arranging an electrically actuatable isolating switch in the first electrical line, the isolating switch configured to interrupt a flow of current in the first electrical line;
arranging an overcurrent protection device in a second electrical line the second electrical line configured to supply power to the isolating switch; and
interrupting, with the overcurrent protection device, a flow of current in the second electrical line to control the isolating switch so as to interrupt the flow of current in the first electrical line.

9. The method for isolating a battery as claimed in claim 8, further comprising:
controlling the second electrical line with a battery management system such that a flow of current configured to trip the overcurrent protection device is produced in the second electrical line.

10. A motor vehicle, comprising:
a power supply device including:
a first electrical line;
at least one battery connected to the first electrical line;
an electrically actuatable isolating switch arranged in the first electrical line and configured to interrupt a flow of current in the first electrical line;
a second electrical line configured to supply power to the isolating switch; and
an overcurrent protection device arranged in the second electrical line and configured to interrupt a flow of current in the second electrical line to control the isolating switch so as to interrupt the flow of current in the first electrical line.
